(19) United States
(12) Patent Application Publication
(10) Pub. No.: US 2015/0193849 A1
(43) Pub. Date: Jul. 9, 2015

(54) SERVICE QUOTATION PROCESSING

(71) Applicants: Steven Bubulj, Sydney (AU); John Flinn, Sydney (AU)

(72) Inventors: Steven Bubulj, Sydney (AU); John Flinn, Sydney (AU)

(73) Assignee: INSURANCE MANUFACTURERS OF AUSTRALIA PTY LIMITED, Sydney, New South Wales (AU)

(21) Appl. No.: 14/410,035

(22) PCT Filed: Jun. 22, 2012
(86) PCT No.: PCT/AU2012/000734

§ 371 Date: Mar. 6, 2015

(51) Int. Cl. G06Q 30/06

(52) U.S. Cl. CPC G06Q 30/0611

(57) ABSTRACT

This disclosure provides computer-implemented methods, computer systems and computer programs for service quotation processing. In one aspect, there is provided a computer-implemented method for repair quotation processing, the method being implemented using a first processing device. The method comprises(a) receiving quotations from a second processing device associated with a service provider, wherein each quotation is associated with a service provided by the service provider; (b) sending, in response to each quotation, a quotation authorisation to the second processing device; and (c) for a batch of quotations, adjusting the quotations to distribute any cost deviation between (i) an aggregate predetermined service cost that is agreed between the service provider and an insurer for the batch, and (ii) an aggregate quoted service cost for the batch, across the quotations in the batch.

### TECHNICAL FIELD

This disclosure relates to computer-implemented methods, computer systems and computer programs for service quotation processing.

### BACKGROUND

Insurance company assessors and service providers, such as but not limited to repairers, generally negotiate the cost of a service provided by the service provider on a quote-by-quote basis. A service provider prepares a quote showing a list of operations required, and an estimated time for each operation. The assessor may then adjust the quote and send it back to the service provider 122. If the service provider agrees with the adjustments, the insurance company will authorise the quote. If the original quote needs to be adjusted, the same process is repeated.

### SUMMARY

According to a first aspect, there is provided a computer-implemented method for service quotation processing, the method being implemented using a first processing device and comprising:
(a) receiving quotations from a second processing device associated with a service provider, wherein each quotation is associated with a service provided by the service provider;
(b) sending, in response to each quotation, a quotation authorisation to the second processing device; and
(c) for a batch of quotations, adjusting the quotations to distribute any cost deviation between (i) an aggregate predetermined service cost that is agreed between the service provider and an insurer for the batch, and (ii) an aggregate quoted service cost for the batch, across the quotations in the batch.

Using the method, the service quotation process does not require any assessments and subsequent adjustments, by an insurer assessor. As the predetermined service cost is agreed between the service provider and the insurer for a batch of quotations, the service provider is incentivised to achieve the agreed cost. The method may be applied to service quotation processing of insured properties such as vehicles, buildings, building contents, personal items, etc.

Each quotation may include labour-related quote items and nonlabour-related quote items, and is adjusted based on relative contribution of the labour-related quote items in the quotation to the cost deviation.

The labour-related quote items may be each calculated based on a labour time and a first labour rate, and adjusting the quotations comprises determining a second labour rate to recalculate the labour-related quote items in each quotation using the second labour rate instead of the first labour rate.

The second labour rate may comprise deducting aggregate quoted cost of the nonlabour-related quote items from the aggregate predetermined service cost for the batch, and dividing the remainder by the total labour time to obtain the second labour rate. In this case, the method may further comprise determining whether the second labour rate is within an acceptable range, and performing (c) only when determination is affirmative.

Each quotation may include labour-related quote items and nonlabour-related quote items, and is adjusted based on relative contribution of both labour-related and nonlabour-related quote items to the cost deviation. In this case, adjusting each quotation may comprise:
determining the quotation's relative contribution to the aggregate quoted service cost based on both the labour-related and nonlabour-related quote items in the quotation;
using the quotation's relative contribution to the aggregate quoted service cost, determining the quotation's relative contribution to the cost deviation; and
adjusting the amount of each quotation by the quotation's relative contribution to the cost deviation.

The predetermined service cost for the batch may be determined based on an average service cost for each service job that is agreed between the service provider and the insurer.

The service may be for repairing, rebuilding, restoring or replacing one or more properties insured by the insurer. For example, each quotation may be associated with a vehicle repair job, and the labour-related quote items include items associated with one or more of:
removal and replacement (R&R) of the vehicle's part;
repair of the vehicle's part; and
painting of the vehicle's part.

The method may further comprise receiving payment requests for the adjusted quotations from the second processing device, and processing the payment requests.

The method may further comprise selecting the service provider from multiple service providers and sending a request for quotation to the service provider before step (a).

Step (c) may be performed at the end of a predetermined accounting period, or once the number of quotations received meets a predetermined batch size.

According to a second aspect, there is provided a computer program comprising machine-executable instructions to cause a processing device to implement the method of the first aspect.

According to a third aspect, there is provided a computer system for service quotation processing, the system comprises a first processing device to:
(a) receive quotations from a second processing device associated with a service provider, wherein each quotation is associated with a service provided by the service provider;
(b) send, in response to each quotation, a quotation authorisation to the second processing device; and
(c) for a batch of quotations, adjust the quotations to distribute any cost deviation between (i) an aggregate predetermined service cost that is agreed between the service provider and an insurer for the batch, and (ii) an aggregate quoted service cost for the batch, across the quotations in the batch.

According to a fourth aspect, there is provided a computer-implemented method for service quotation processing, the method being implemented using a second processing device associated with a service provider and comprising:
(a) sending multiple quotations to a first processing device associated with an insurer, wherein each quotation is associated with a service provided by the service provider;
(b) receiving, in response to each quotation, a quotation authorisation from the first processing device;
(c) receiving a batch of adjusted quotations from the first processing device, wherein the quotations in the batch are adjusted to distribute any cost deviation between (i) an aggregate predetermined service cost that is agreed between the service provider and an insurer for the batch, and (ii) an aggregate quoted service cost for the batch, across the quotations in the batch; (d) in response to the adjusted quotations, sending a payment request to the first processing device based on the adjusted quotations.

According to a fifth aspect, there is provided a computer program comprising machine-executable instructions to cause a processing device to implement the method of the fourth aspect.

According to a sixth aspect, there is provided a computer system for service quotation processing, the system comprises a second processing device associated with a service provider to:
(a) send multiple quotations to a first processing device associated with an insurer, wherein each quotation is associated with a service provided by the service provider;
(b) receive, in response to each quotation, a quotation authorisation from the first processing device;
(c) receive a batch of adjusted quotations from the first processing device,
wherein the quotations in the batch are adjusted to distribute any cost deviation between (i) an aggregate predetermined service cost that is agreed between the service provider and an insurer for the batch, and (ii) an aggregate quoted service cost for the batch, across the quotations in the batch;
(d) in response to the adjusted quotations, send a payment request to the first processing device based on the adjusted quotations.

While clearly inherent from the summary above we explicitly note here that the order of steps (b) and (c) is not important. We have described here that step (c) of adjusting quotations occurs after step (b) of authorisation. A person skilled in the art would clearly recognise that step (b) could in fact occur after or together with step (c) and is within the scope of the method, system and software described here.

Optional features described above in relation to the the first aspect may also be optional features of the second to sixth aspect where appropriate.

### BRIEF DESCRIPTION OF THE DRAWINGS

Non-limiting example(s) will now be described with reference to the accompanying drawings, in which:

FIG. 1 is a schematic diagram of an example computer system for service quotation processing;

FIG. 2 is a flowchart of an example computer-implemented method for service quotation processing;

FIG. 3 is an example user interface provided by the system to create a quotation;

FIG. 4 is a continuation of the example user interface in FIG. 3;

FIG. 5 is a flowchart of a first example implementation for quotation adjustment;

FIG. 6 is an example user interface provided by the system to review and update a batch of quotations based on the first example implementation;

FIG. 7 is an example quotation that is adjusted according to the first example implementation;

FIG. 8 is a continuation of the updated quotation in FIG. 7;

FIG. 9 is a flowchart of a second example implementation for quotation adjustment;

FIG. 10 is an example user interface provided by the system to review and update a batch of quotations based on the second example implementation;

FIG. 11 is an example quotation that is adjusted according to the second example implementation;

FIG. 12(a) is an example user interface for reviewing an invoice for the quotation adjusted according to the first example implementation;

FIG. 12(b) is an example user interface for reviewing an invoice for the quotation adjusted according to the second example implementation; and

FIG. 13 is a schematic diagram of an example processing device to implement the method in FIG. 2.

### DETAILED DESCRIPTION

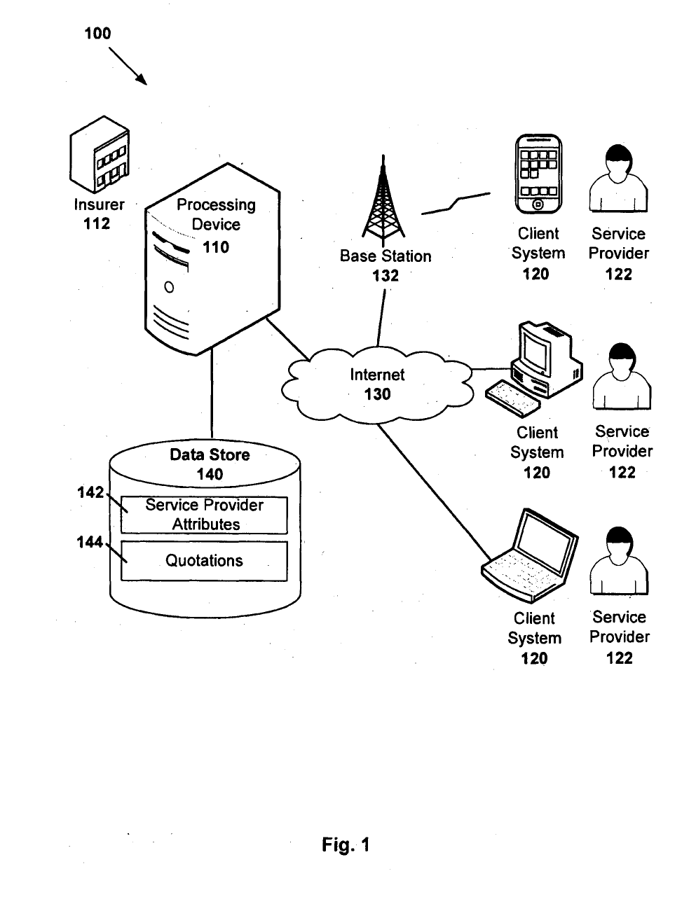

Referring first to FIG. 1, the computer system 100 for service quotation processing includes a processing device 110 (“first processing device”) in communication with multiple client systems 120 (“second processing devices”) via a wide area communications network 130, 132 such as the Internet.

The processing device 110 is generally a server operated by an insurance company or insurer 112 who offers insurance products to users. For example, an insurance product may provide an insured user with cover against accidental damage, malicious damage, theft, fire, flood or storm. The “property” may be a vehicle, building, building content (e.g. carpet, glass), computer equipment, jewellery, etc. The “insured user” may be an owner, manager or user (e.g. tenant or lessee) of a property, and may be a person or legal entity.

The client systems 120 are each associated with (e.g. operated by) a service provider 122 at a service shop that may be mobile or at a fixed location. For example, the service may be for repairing, rebuilding, restoring or replacing one or more properties insured by the insurer 112. As such, the service provider 122 may be a repairer, builder, restorer or similar professional. The client system 120 may be any suitable processing device, such as a server, desktop computer, laptop computer, tablet computer, or mobile communication device.

The processing device 110 has access to a data store 140 to store and retrieve information required for service quotation processing, such as service provider attributes 142, and quotations 144 received from the service providers 122. Service provider attributes 142 may include each service provider's 122 address information, contact person, capabilities (types of service jobs that can be performed), tax invoice information and contact details etc.

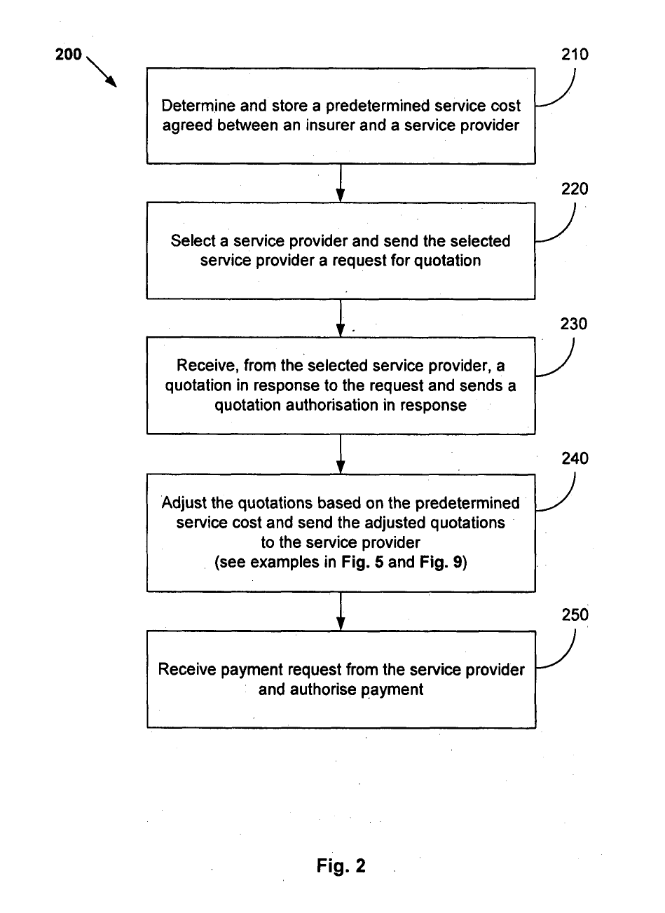

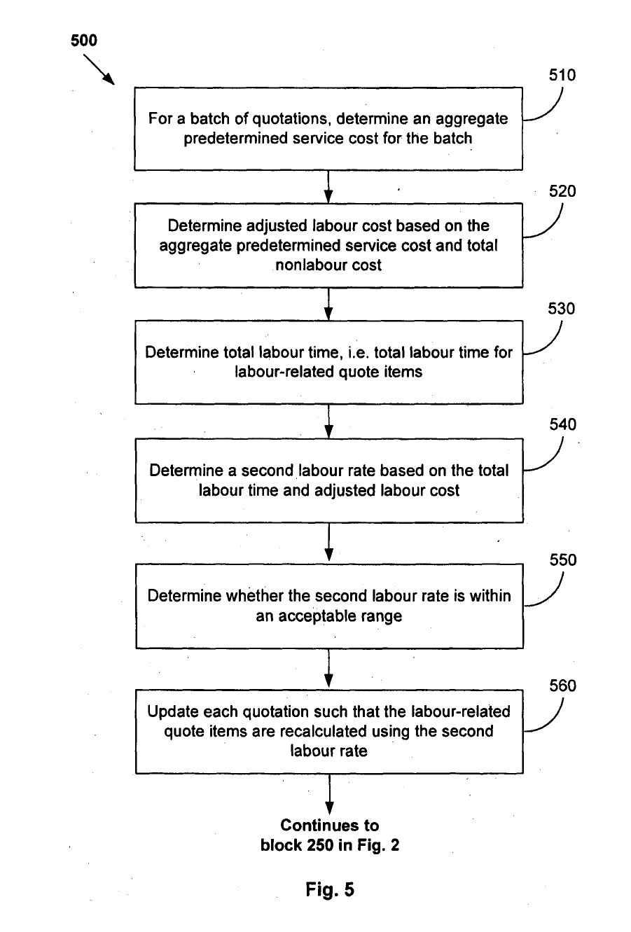

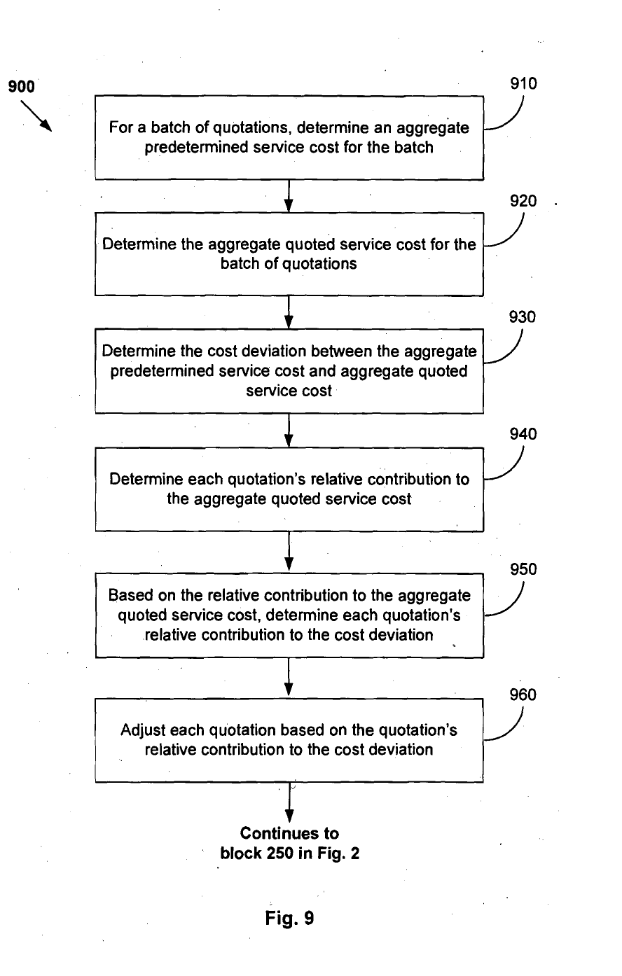

In the event of an insurance claim, a selected service provider 122 provides a quotation for a service provided by the service provider 122, and the insurer 112 generally manages the service and may perform a post-service quality check. Referring to FIG. 2, a flowchart of an example method for service quotation processing is shown:
At block 210, a setup process is performed in which the processing device 110 determines a predetermined service cost for each service job, and a labour rate (“first labour rate”) agreed between the insurer 112 and the service provider 122. In one example implementation, the predetermined service cost for each job is an average service cost agreed between the insurer 112 and the service provider 122.
At block 220, upon receiving an insurance claim from an insured user, the processing device 110 selects a service provider 122 and sends a request for quotation to the selected service provider 122.
At block 230, the processing device 110 receives a quotation from the selected service provider 122. Each quotation is associated with a service provided by the service provider 122 and includes labour-related quote items that are each calculated based on labour time and the first labour rate, and optionally nonlabour-related quote items. In response, the processing device 110 sends a quotation authorisation to the service provider 122, without requiring an assessor to adjust the quotation.
At block 240, for a batch of quotations, the processing device 110 adjusts the quotations to distribute any cost deviation between (i) an aggregate predetermined service cost that is agreed between the service provider and an insurer for the batch, and (ii) an aggregate quoted service cost for the batch, across the quotations in the batch. The adjusted quotations are then sent to the service provider 122.
In a first example implementation, each quotation is adjusted based on the relative contribution of labour-related quote items to the cost deviation; see FIG. 5. In a second example implementation, each quotation is adjusted based on the relative contribution of both labour-related and non-labour related items to the cost deviation; see FIG. 9.
At block 250, the processing device 110 receives payment request(s) from the service provider 122 in relation to the updated quotations and authorise payment if the amount matches with that of the updated quotations.

Advantageously, the service quotation process is automatic, and does not require any assessments and subsequent adjustments, by an insurer assessor. Since the predetermined service cost is agreed, a service provider 122 is incentivised to reduce quote items (and labour time required in some cases) on a quotation to increase profitability, instead of maximising quotes for assessors to mitigate. The reduction of the quote items may reduce cycle time, which in turn increases the volume of work, which further improves profitability. Further, resources may be focussed on the quality of service, instead of the negotiation or assessment process between the insurer 112 and the service provider 122. The method is a form of a “predictable cost model”.

The method may be applied to all or some of the quotations received from the service provider 122. In the latter case, one or more filtering criteria are applied to the quotations, and only those satisfying the criteria are processed according to blocks 240 and 250. For example, the filtering criteria may include one or more of: type of service, quotation amount, and profitability criteria set by the insurer 112.

The flowchart in FIG. 2 will be explained in more detail below. In the rest of the document, the method in FIG. 2 is exemplified using vehicle repair quotation processing. However, it will be appreciated that the method may be applied to service quotation processing for other types of service, such as for rebuilding, restoring or replacing a property. As discussed above, the property may also be a building, building contents and personal items etc.

System Setup (Block 210)

At block 210 in FIG. 1, a setup process is performed in which the processing device 110 determines, and stores, the following in the data store 140 as the service provider's 122 attributes 142:
(i) A predetermined service cost that is agreed between the insurer 112 and the service provider 122 for each service provided by the service provider 122. In one example implementation, the predetermined service cost is an average service cost agreed between the parties. For example, for a particular service provider 122, the agreed average service cost may be $1850 for each service job allocated to the service provider 122.
The agreed average service cost may be determined based on historical data, best in market performance, negotiations based on cost and volume, profit and loss/productivity and efficiency analysis, and open market exercises. The average service cost is locked in for a predetermined period (e.g. 12 months) and/or adjusted over time.
(ii) A labour rate (“first labour rate”) that is agreed between the insurer 112 and the service provider 122, such as an hourly labour rate of $82. The labour rate is generally determined based on the service provider's 122 labour costs, productivity and available working hours. The labour rate generally differs from one service provider to another.
(ii) Optionally, an estimated number of service jobs (volume) at the agreed average service cost that will be allocated to the service provider 122 by the insurer 112. For example, a block of 80 jobs at $1850 each may be agreed between the insurer and the service provider 122.

The processing device 110 may adjust the agreed average service cost over time. This may include changes to business structure, relationship status, and changes in economic conditions. This may be adjusted to take into account performance measures such as productivity and efficiency. A sliding volume discount may also be automatically applied by the processing device 110 based on criteria set by the insurer 112.

It will be appreciated that although an average service cost has been used to exemplify the “predetermined service cost”, other forms may be used. In one example, a sliding volume discount may also be automatically applied by the processing device 110 based on criteria set by the insurer 112. In this case, the predetermined service cost may include multiple average service costs: a first average service cost is used for a first group of service jobs (e.g. $2000 for the first 50 jobs); a second average service cost for a second group; and so on (e.g. $1600 for each subsequent job).

Service Provider Selection and Quotation Request (Block 220)

At block 220 in FIG. 1, upon receiving an insurance claim from an insured user, the processing device 110 selects a service provider 122 and sends a request for quotation to the selected service provider 122 for the service job.

Selection of the service provider 122 may depend on a number of service provider attributes 142, such as the location of the service provider 122 and whether the service provider is capable of performing the necessary service. Data is stored on the service provider's premises and equipment audits, along with any specialist capabilities, which is then matched by the processing device 110 to customer needs such as property attribute (e.g. vehicle type) and damage profile.

Once the request is received, the selected service provider 122 submits the quotation for the particular service job via the client system 120. The quotation is submitted after the selected service provider 122 inspects the damaged property insured by the insurer 112.

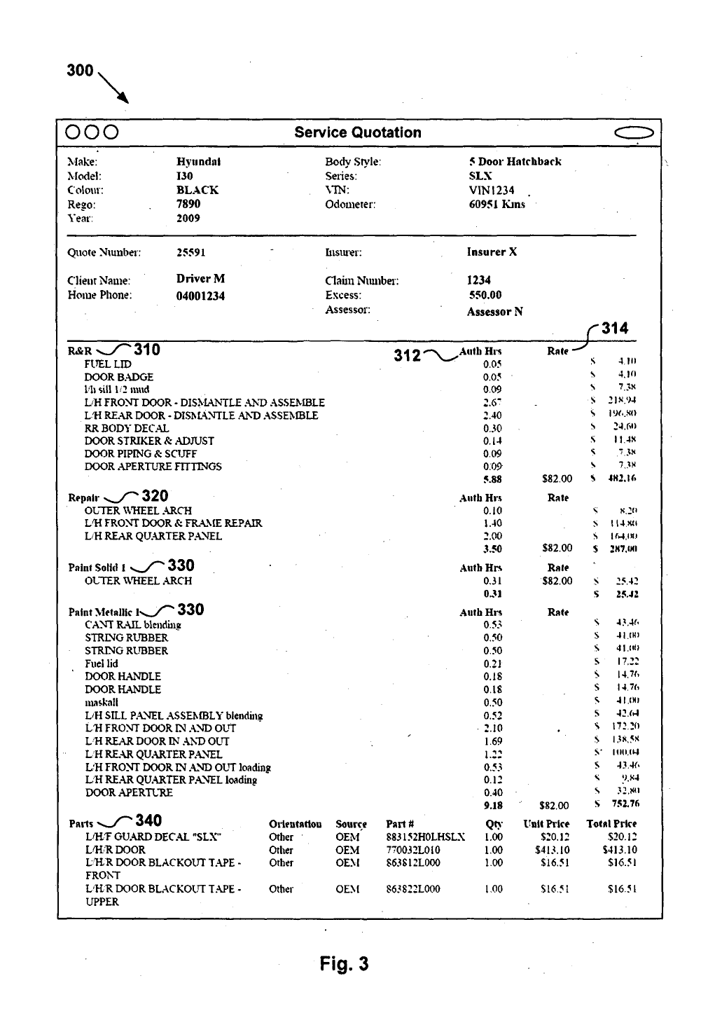

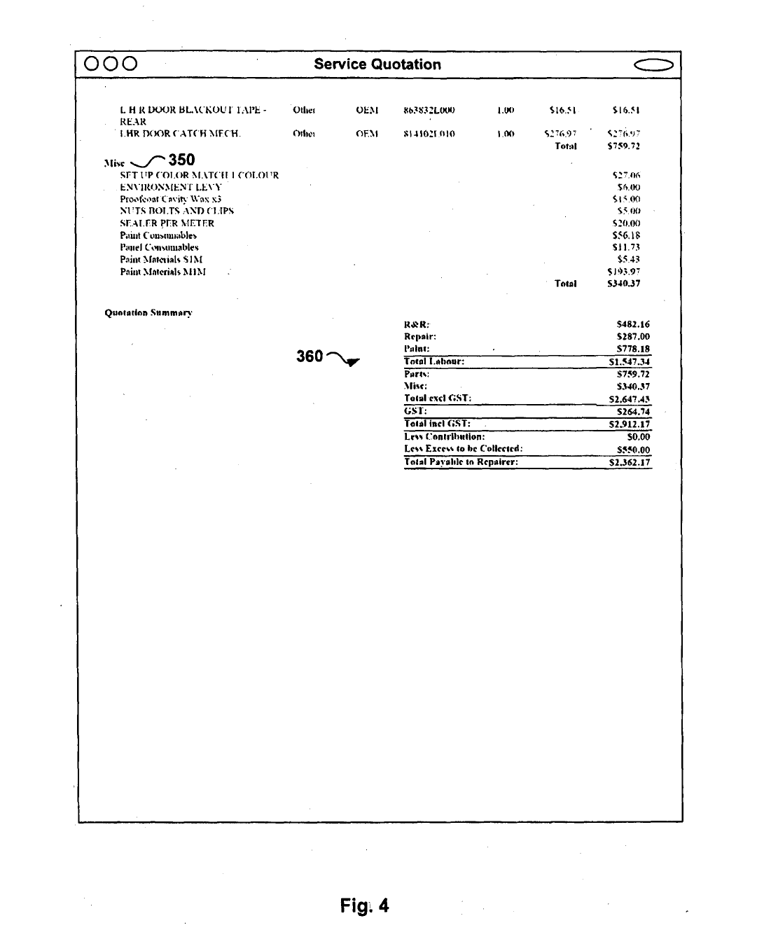

FIG. 3 and FIG. 4 show an example user interface 300 provided by the processing device 110 for a service provider 122 to submit a quotation via the client system 120. In this example, the quotation is based on a model called New Times and Rates (NTAR) or Realistic Times and Rates for vehicle repair. The quotation sets out a list of labour-related and nonlabour-related quote items, and the cost for each item.

For example, the labour-related quote items for a vehicle repair job include items in the following categories:
(a) remove and replace (“R&R”) damaged and other parts 310;
(b) repair of damaged parts 320; and
(c) painting of parts 330.

Each quote item in the above categories is quoted based on labour time 312 and the first labour rate 314 of the service provider 122 (e.g. $82 in this example). The times on the quotation are generally expected times to carry out the operations based on time trials conducted by an industry body or the insurer 112.

The nonlabour-related quote items include replacement parts 340 and miscellaneous costs 350 such as sublet items, paint/panel consumables such as sand paper, masking tape etc; see FIG. 4. The quotation also includes a summary 360 of the sub-total in each category, and any government charges and excess payable by the insured user.

In the example in FIG. 3 and FIG. 4, the first labour rate in the quotation is $82 per hour, the total labour time (number of hours for R&R, repair and paint) is 18.87 hours, and the quoted labour cost is therefore $1,547.34 (see 360 in FIG. 4).

Quotation Authorisation (Block 230)

At block 230 in FIG. 1, the processing device 110 receives the quotation submitted by the service provider 122 via the client system 120. In response, the processing device 110 automatically sends a quotation authorisation to the service provider 122, without requiring the participation of an assessor.

The processing device 110 also proceeds to record details of the damage, including the list of repair operations required.

Blocks 220 and 230 may be repeated multiple times within an accounting period (e.g. a month) based on when the number of authorised quotations reaches a predetermined number. Each authorised quotation is stored in the data store 140.

Quotation Adjustment (Block 240)

At block 240 in FIG. 1, the processing device 110 adjusts each quotation in a batch of quotations to distribute any cost deviation between (i) an aggregate predetermined service cost that is agreed between the service provider and an insurer for the batch, and (ii) an aggregate quoted service cost for the batch, across the quotations in the batch. In an alternative explain, the processing device 110 may at this stage rather than at 230 automatically sendsa quotation authorisation to the service provider and proceed to record details of the damage, including the list of service operations required.

This step may be performed when a batch of quotations received meets a predetermined batch size (e.g. 80 jobs), or at the end of an accounting period. The processing device 110 then sends the adjusted quotations to the service provider 122 via their client system 120.

Two example implementations for adjusting the quotations based on the predetermined service cost will be explained in (a) and (b) below.

(a) Relative Contribution of Labour Cost to Cost Deviation

According to a first example implementation, each quotation is adjusted based on the relative contribution of the labour-related quote items to the cost deviation. In one example, the processing device 110 adjusts the labour-related quote items in each quotation using a second (adjusted) labour rate.

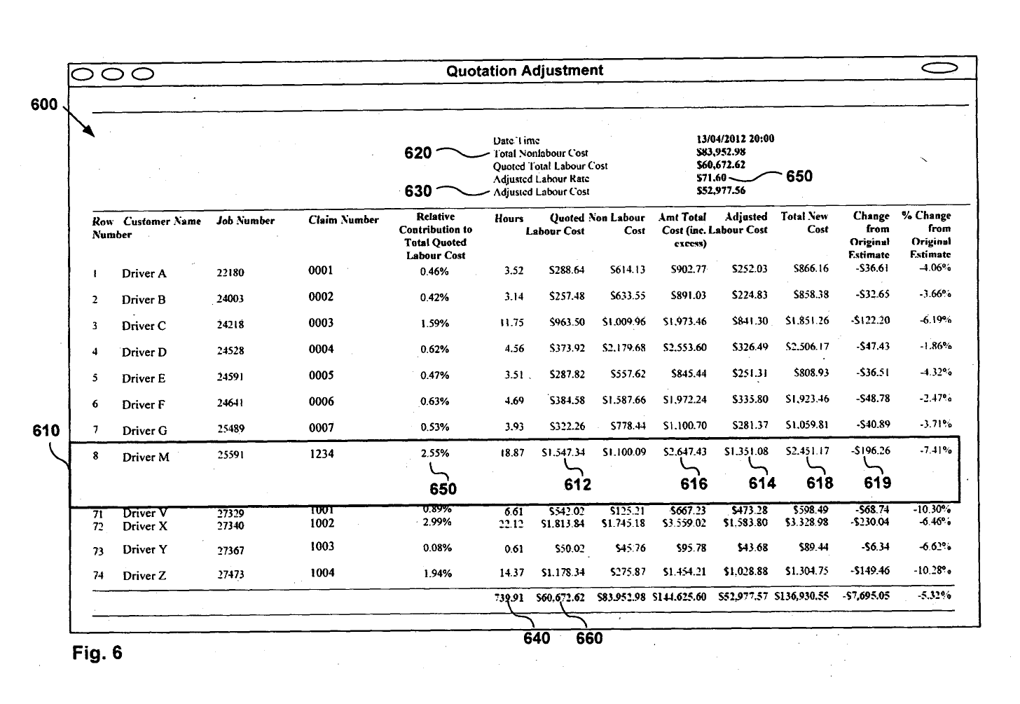

One example method of calculating the second labour rate will now be explained using the flowchart 500 in FIG. 5, and example user interface 600 in FIG. 6 which lists a batch of 74 quotations received from the service provider 122. Note that quotations no. 9 to 70 are not shown in FIG. 6 for simplicity. One of the quotations (no. 8, labelled 610) is the quotation discussed along with FIG. 3 and FIG. 4.

In particular, the processing device 110 determines the following:
(i) Aggregate predetermined service cost that is agreed between the insurer 112 and service provider 122 for the batch of quotations. In one example, the aggregate predetermined service cost is calculated as the agreed average service cost multiplied by the number of quotations received; see block 510 in FIG. 5. In the example in FIG. 6, the agreed average service cost is $1850.41, and 74 service jobs were completed within the accounting period. In this case, the aggregate predetermined service cost is $136,930.55 (i.e. $1850.41×74).
(ii) Adjusted labour cost, which is determined as the aggregate predetermined service cost subtracted by the nonlabour-related quote items in the batch of quotations; see block 520 in FIG. 5. In the example in FIG. 6, the aggregate quoted nonlabour cost is $83,952.98 and the adjusted labour cost is therefore $52,977.56 (i.e. $136,930.55-$83,952.98); see labels 620 and 630 respectively.
(iii) Total labour time, which is determined as the total number of labour hours in the batch of quotations across R&R, Paint and Repair categories; see block 530 in FIG. 5. In the example in FIG. 6, the total labour hour is 739.91 hours; see label 640.
(iv) Adjusted labour rate (second labour rate), which is determined as the adjusted labour cost divided by the total labour time; see block 540 in FIG. 5. In the example in FIG. 6, the adjusted labour rate is $71.60 (i.e. $52,977.56 divided by 739.91); see label 650.

In this example, the second labour rate is determined such that the aggregate adjusted service cost (e.g. adjusted labour revenue of $52,977.56+total nonlabour cost of $83,952.98) accords with aggregate average service cost (e.g. $136,930.55=$1850.41×74).

Referring to FIG. 5 again, the processing device 110 then proceeds to check whether the adjusted labour rate is within an acceptable range; see block 550. For example, the acceptable range may be between $65 and $120, which is set by the insurer 112.

If the adjusted rate is acceptable, the processing device 110 proceeds to update the items in each quotation according to the adjusted labour rate. In other words, the adjustment would result in the costs in separate quotations being adjusted up or down but the total amount in the quotations accords with the aggregate service cost. Otherwise, if the adjusted rate is unacceptable, the processing device 110 notifies a responsible person for further review.

In the example in FIG. 6, the example quotation 610 is being adjusted down because the second labour rate of $71.60 is used instead of the first labour rate of $82.00 previously stored; see label 650. For this particular quotation:
(i) The labour cost is adjusted to $1,351.08, which is down from $1,547.34 previously quoted; see labels 612 and 614; and
(ii) The total new cost is $2,451.17, which is down from $2,647.43 previously quoted; see labels 616 and 618. The percentage change is −7.41%, and the adjustment is −$196.26; see label 619.

In other words, the adjustment is based on the relative contribution of the labour-related quote items in each quotation to the overall cost deviation. More specifically:
(i) The cost deviation is −7,695.05, which is the difference between the aggregate predetermined service cost of $136,930.55 and aggregate quoted service cost of $144,625.60.
(ii) The relative contribution of the labour-related quote items in the example quotation 610 to the total labour cost is 2.55% (see label 650), which is calculated as the quotation's labour cost of $1,547.34 (see label 612) divided by the total labour cost of $60,672.62 (see label 660).
(iii) The adjustment for this quotation 610 is therefore 2.55% of the cost deviation of −7,695.05, which is −$196.26 (see label 619)

Although not shown in this example, it will be appreciated that the second labour rate may be more than the first labour rate, if the total labour hours are less than benchmark, or if parts components are less than average with a higher labour total. Of course, the second labour rate may be the same as the first labour rate if the total labour hours are the same as benchmark, or if parts components are the same as benchmark.

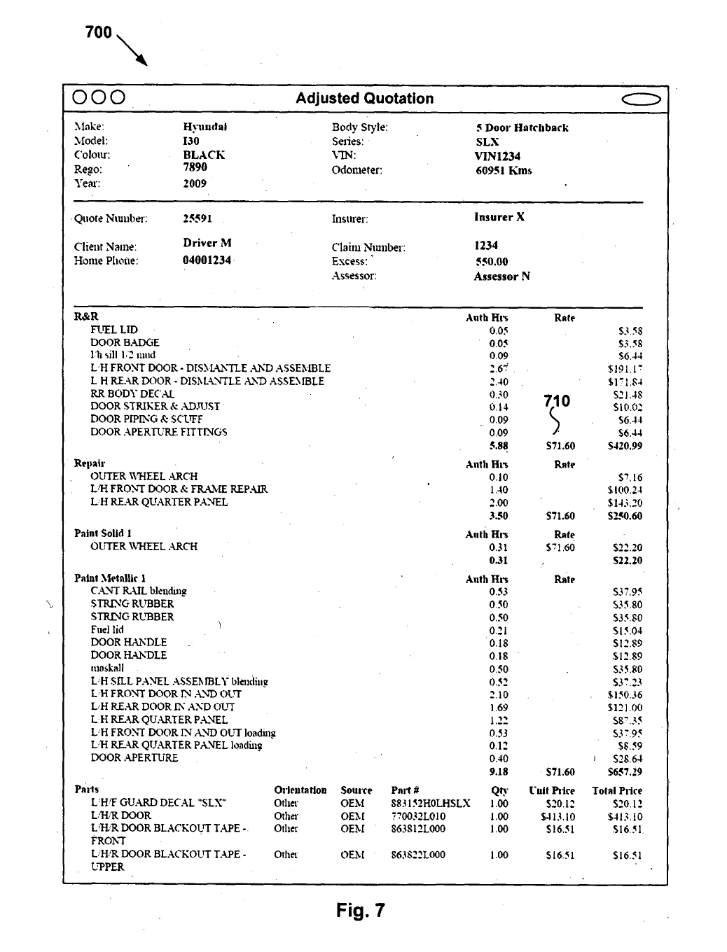

FIG. 7 shows an example updated quotation generated by the processing device 110 after the adjustment according to the method in FIG. 5, where the initial quotation in FIG. 3 and FIG. 4 is updated using the second labour rate of $71.60; see label 710.

The labour-related quote items under categories R&R, repair and paint are recalculated using the same labour time, but the second labour rate of $71.60 instead of the first labour rate of $82. Comparing quote items in the R&R category, the new subtotal for the category is $420.99 (i.e. 5.88×$71.60) instead of $482.16 (i.e. 5.88×$82.00).

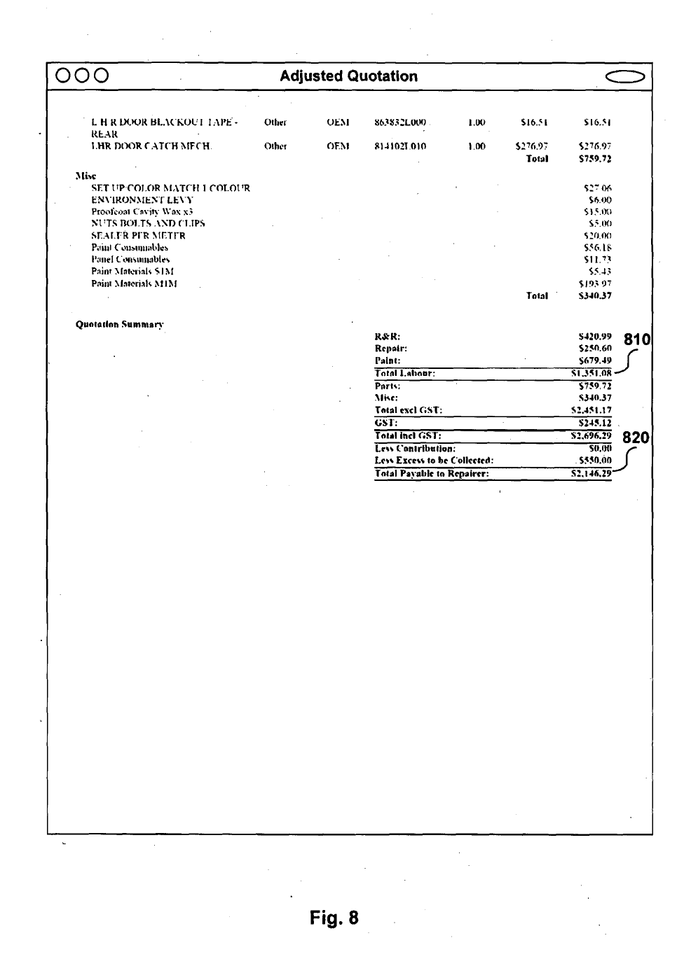

The total labour cost at $71.60 per hour is $1,351.08 (see 810 in FIG. 8) instead of $1,574.34 in FIG. 4. Also, taking into account $550 of excess payable by the insured user, the total payable is $2,146.29 (see 820 in FIG. 8) instead of $2,362.17 in FIG. 4.

(b) Relative contribution of quoted cost to cost deviation

In a second example implementation, each quotation is adjusted based on the relative contribution of both labour-related and nonlabour-related quote items to the cost deviation.

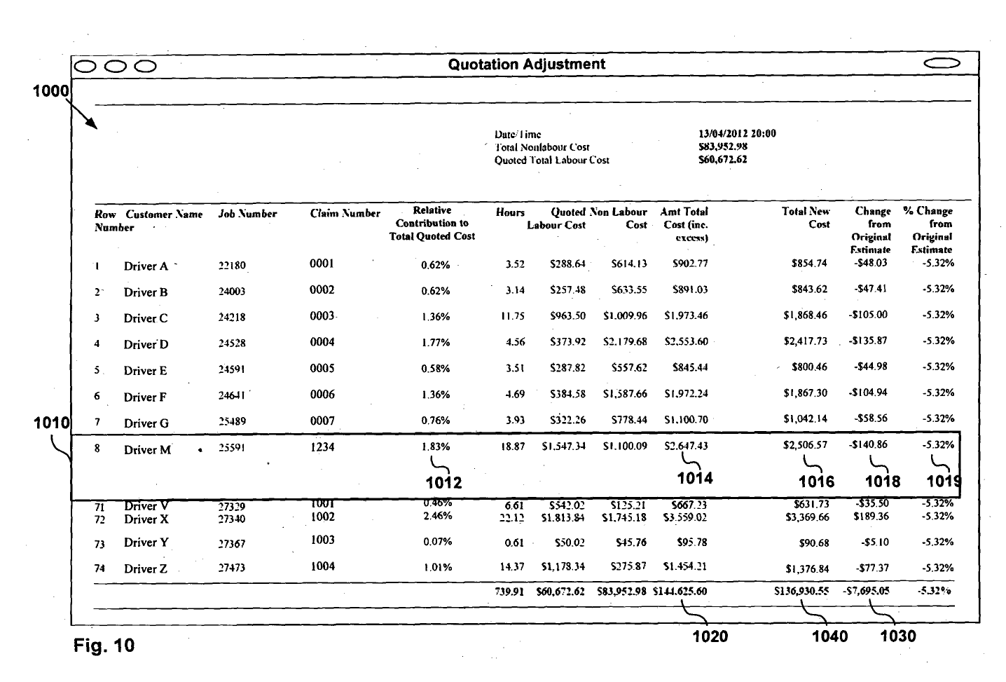

In one example, a new item is added to each quotation to adjust quoted amount, while the labour-related and nonlabour-related quote items remain unchanged. The method will now be explained using the flowchart 900 in FIG. 9, and example user interface 1000 in FIG. 10 that lists a batch of 74 quotations received from the service provider 122. Similarly to FIG. 6, quotations no. 9 to 70 are not shown in FIG. 10 for simplicity. One of the quotations (no. 8, labelled 1010) is the quotation discussed along with FIG. 3 and FIG. 4.

Referring to FIG. 9 and FIG. 10, the processing device 110 determines the following:
(i) Aggregate predetermined service cost that is agreed between the insurer 112 and service provider 122 for the batch of quotations; see block 910 in FIG. 9. In the example in FIG. 10, the agreed average service cost is $1850.41, and there are 74 service jobs in the batch. In this case, the aggregate predetermined service cost is $136,930.55 (i.e. $1850.41×74).
(ii) Aggregate quoted service cost of the quotations in the batch, which is the sum of all quotations in the batch; see block 920 in FIG. 9. In the example in FIG. 10, the aggregate service cost is $144,625.60; see label 1020.
(iii) Cost deviation between the aggregate predetermined service cost and the aggregate quoted service cost; see block 930 in FIG. 9. In FIG. 10, the cost deviation is −$7,695.05, which is $136,930.55−$144,625.60; see label 1030.
(iv) Relative contribution of each quotation to the aggregate quoted service cost based on both labour-related and nonlabour-related quote items in the quotation; see block 940 in FIG. 9. In the example quotation 1010 in FIG. 10, the relative contribution of this quotation is 1.83%, which is $1,547 divided by the $144,625.60; see labels 1012, 1014 and 1020 respectively.

(v) Adjustment amount of each quotation based on the relative contribution of each quotation to the aggregate quoted service cost; see block 950 in FIG. 9. In the example in FIG. 10, the adjustment amount is 1.83% of the cost deviation of −$7,695.05, which amounts to −$140.86; see labels 1012, 1020 and 1018 respectively. In other words, the adjustment amount represents the quotation's 1010 relative contribution to the cost deviation.

The processing device 110 then adjusts the quotation accordingly; see block 960 in FIG. 9. In the example in FIG. 10, the amount after adjustment is $2,506.57 which represents a decrease of −5.32%; see labels 1016 and 1019 respectively. The sum of all adjusted quotations is indicated using label 1040, which corresponds to the aggregate predetermined service cost of $136,930.55.

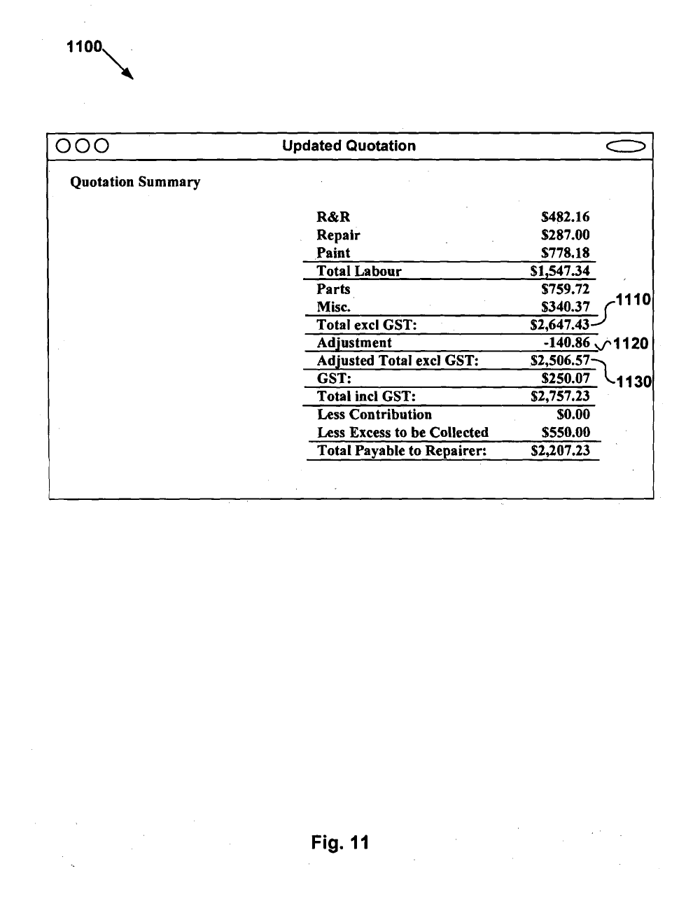

FIG. 11 shows the quotation summary of a quotation adjusted by the processing device 110 according to the method in FIG. 9, where the quoted amount of $2,647.43 in FIG. 3 and FIG. 4 is adjusted by −$140.86 to $2,506.57; see labels 1110, 1120 and 1130 respectively.

Payment Processing (Block 250)

At block 250 in FIG. 2, the processing device 110 receives invoices from the service provider 122 for the adjusted quotations in block 240.

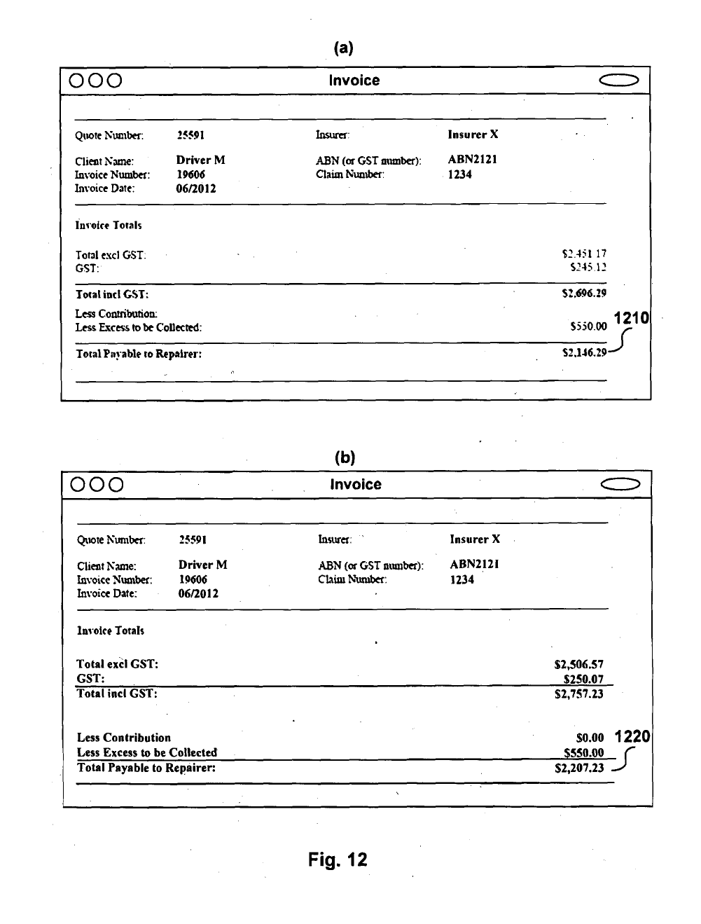

FIG. 12(a) shows an example user interface to display an invoice for the adjusted quotation in FIG. 7 and FIG. 8. In this case, the amount payable by the insurer 112 to the service provider 122 is $2,146.29 based on an adjusted labour rate of $71.60; see label 1210. This amount is after adding GST (Goods and Services Tax) and deducting excess payable by the insured user.

FIG. 12(b) shows another example user interface to display an invoice for the adjusted quotation in FIG. 9. In this case, the amount payable is by the insurer 112 to the service provider 122 is $2,207.23; see label 1220. Similarly, this amount is after adding GST (Goods and Services Tax) and deducting excess payable by the insured user.

If the invoice amount for each job matches with the amount adjusted at block 240, the processing device 110 sends a payment authorisation to the service provider 122. Otherwise, if there are discrepancies, a responsible person will be notified and the payment request manually managed.

Processing Device 110/120

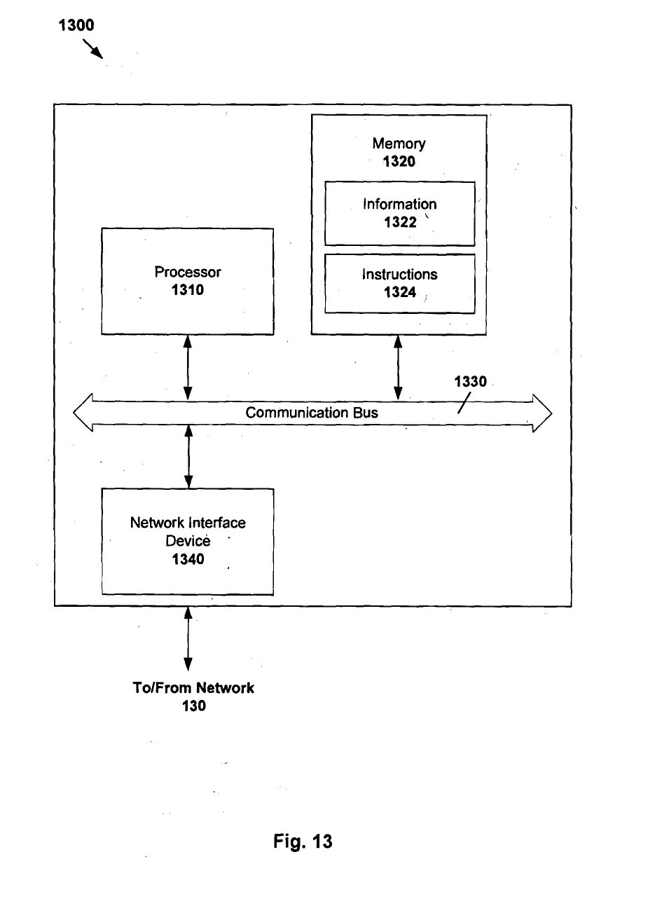

The example method in FIG. 2 can be implemented by hardware, software or firmware or a combination thereof. Referring to FIG. 13, an example structure of a processing device 1300 capable of acting as a processing device 110/120 is shown in FIG. 1.

The example device 1300 includes a processor 1310, a memory 1320 and a network interface device 1340 that communicate with each other via a communication bus 1330.

Information may be transmitted and received via the network interface device 1340, which may include one or more logical or physical ports that connect the device 1300 to another network device.

For example, the various methods, processes and functional units described herein may be implemented by the processor 1310. The term ‘processor’ is to be interpreted broadly to include a CPU, processing unit, ASIC (application-specific integrated circuit), logic unit, or programmable gate array etc. The processes, methods and functional units may all be performed by a single processor 1310 or split between several processors (not shown in FIG. 13 for simplicity); reference in this disclosure or the claims to a ‘processor’ should thus be interpreted to mean ‘one or more processors’.

Although one network interface device 1340 is shown in FIG. 13, processes performed by the network interface device 1340 may be split between several network interface devices. As such, reference in this disclosure to a ‘network interface device’ should be interpreted to mean ‘one or more network interface devices’.

The processes, methods and functional units may be implemented as machine-readable instructions executable by one or more processors, hardware logic circuitry of the one or more processors or a combination thereof. In the example in FIG. 13, the machine-readable instructions 1324 are stored in the memory 1320. Other information 1322 such as service provider attributes, quotations and invoices required by the processing device 110 may be stored in the memory 1320, or remote data stores (see 140 in FIG. 1).

Further, the processes, methods and functional units described in this disclosure may be implemented in the form of a computer program product. The computer program product is stored in a computer-readable storage medium and comprises a plurality of computer-readable instructions for making a device 1300 implement the methods recited in the examples of the present disclosure.

The figures are only illustrations of an example, wherein the units or procedure shown in the figures are not necessarily essential for implementing the present disclosure. Those skilled in the art will understand that the units in the device in the example can be arranged in the device in the examples as described, or can be alternatively located in one or more devices different from that in the examples. The units in the examples described can be combined into one module or further divided into a plurality of sub-units.

Although the flowcharts described show a specific order of execution, the order of execution may differ from that which is depicted. For example, the order of execution of two or more blocks may be changed relative to the order shown. Also, two or more blocks shown in succession may be executed concurrently or with partial concurrence. All such variations are within the scope of the present disclosure.

It should also be understood that, unless specifically stated otherwise as apparent from the following discussion, it is appreciated that throughout the description, discussions utilizing terms such as “optimising”, “classifying”, “constructing”, “receiving”, “processing”, “retrieving”, “selecting”, “calculating”, “determining”, “displaying” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices. Unless the context clearly requires otherwise, words using singular or plural number also include the plural or singular number respectively.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A computer-implemented method for quotation processing, the method being implemented using a first processing device and comprising:
(a) receiving quotations from a second processing device associated with a service provider, wherein each quotation is associated with a service provided by the service provider;
(b) sending, in response to each quotation, a quotation authorisation to the second processing device; and
(c) for a batch of quotations, adjusting the quotations to distribute any cost deviation between (i) an aggregate predetermined service cost that is agreed between the service provider and an insurer for the batch, and (ii) an aggregate quoted service cost for the batch, across the quotations in the batch.

2. The method of claim 1, wherein each quotation includes labour-related quote items and nonlabour-related quote items, and is adjusted based on relative contribution of the labour-related quote items in the quotation to the cost deviation.

3. The method of claim 2, wherein the labour-related quote items are each calculated based on a labour time and a first labour rate, and adjusting the quotations comprises determining a second labour rate to recalculate the labour-related quote items in each quotation using the second labour rate instead of the first labour rate.

4. The method of claim 3, wherein determining the second labour rate comprises deducting aggregate quoted cost of the nonlabour-related quote items from the aggregate predetermined service cost for the batch, and dividing the remainder by the total labour time to obtain the second labour rate.

5. The method of claim 3, further comprising determining whether the second labour rate is within an acceptable range, and performing (c) only when determination is affirmative.

6. The method of claim 1, wherein each quotation includes labour-related quote items and nonlabour-related quote items, and is adjusted based on relative contribution of both labour-related and nonlabour-related quote items to the cost deviation.

7. The method of claim 6, wherein adjusting each quotation comprises:
determining the quotation's relative contribution to the aggregate quoted service cost based on both the labour-related and nonlabour-related quote items in the quotation;
using the quotation's relative contribution to the aggregate quoted service cost, determining the quotation's relative contribution to the cost deviation; and
adjusting the amount of each quotation by the quotation's relative contribution to the cost deviation.

8. The method of claim 1, wherein the predetermined service cost for the batch is determined based on an average service cost for each service that is agreed between the service provider and the insurer.

9. The method of claim 1, wherein the service is for repairing, rebuilding, restoring or replacing one or more properties insured by the insurer.

10. The method of claim 1, wherein each quotation is associated with a vehicle repair job, and the labour-related quote items include items associated with one or more of:
removal and replacement (R&R) of the vehicle's part;
repair of the vehicle's part; and
painting of the vehicle's part.

11. The method of claim 1, further comprising receiving payment requests for the adjusted quotations from the second processing device, and processing the payment requests.

12. The method of claim 1, further comprising selecting the service provider from multiple service providers and sending a request for quotation to the service provider before (a).

13. The method of claim 1, wherein (c) is performed at the end of a predetermined accounting period, or once the number of quotations received meets a predetermined batch size.

14. A non-transitory computer readable medium comprising computer-executable instructions stored thereon that when executed to cause a processing device to implement the method of claim 1.

15. A computer system for service quotation processing, the system comprises a first processing device to:
(a) receive quotations from a second processing device associated with a service provider, wherein each quotation is associated with a service provided by the service provider;
(c) for a batch of quotations, adjust the quotations to distribute any cost deviation between (i) an aggregate predetermined service cost that is agreed between the service provider and an insurer for the batch, and (ii) an aggregate quoted service cost for the batch, across the quotations in the batch. A quotation authorisation is sent for each quotation to the second processing device

16. A computer-implemented method for service quotation processing, the method being implemented using a second processing device associated with a service provider and comprising:
(a) sending multiple quotations to a first processing device associated with an insurer, wherein each quotation is associated with a service provided by the service provider;
(b) receiving, in response to each quotation, a quotation authorisation from the first processing device;
(c) receiving a batch of adjusted quotations from the first processing device,
wherein the quotations in the batch are adjusted to distribute any cost deviation between (i) an aggregate predetermined service cost that is agreed between the service provider and an insurer for the batch, and (ii) an aggregate quoted service cost for the batch, across the quotations in the batch;
(d) in response to the adjusted quotations, sending a payment request to the first processing device based on the adjusted quotations.

17. A non-transitory computer readable medium comprising computer-executable instructions stored thereon that when executed to cause a processing device to implement the method of claim 16.

18. A computer system for service quotation processing, the system comprises a second processing device associated with a service provider to:
(a) send multiple quotations to a first processing device associated with an insurer, wherein each quotation is associated with a service provided by the service provider;
(b) receive, in response to each quotation, a quotation authorisation from the first processing device;
(c) receive a batch of adjusted quotations from the first processing device,
wherein the quotations in the batch are adjusted to distribute any cost deviation between (i) an aggregate predetermined service cost that is agreed between the service provider and an insurer for the batch, and (ii) an aggregate quoted service cost for the batch, across the quotations in the batch;
(d) in response to the adjusted quotations, send a payment request to the first processing device based on the adjusted quotations.
